(19) United States
(12) Patent Application Publication
(10) Pub. No.: US 2026/0038258 A1
(43) Pub. Date: Feb. 5, 2026

(54) AUTOMATIC WEBSITE INPUT DETECTION

(71) Applicant: OKTA, INC., SAN FRANCISCO, CA (US)

(72) Inventors: Lu XU, San Jose, CA (US); Ian Kyle SMITH, Denver, CO (US); Tanvir ISLAM, Lake Stevens, WA (US); Tian GAN, San Jose, CA (US); Yuming CAO, San Carlos, CA (US)

(21) Appl. No.: 18/791,169

(22) Filed: Jul. 31, 2024

(51) Int. Cl. G06V 10/94; G06F 9/451; G06V 10/774; H04L 9/40

(52) U.S. Cl. CPC G06V 10/945; G06F 9/451; G06V 10/774; H04L 63/083; G06V 2201/10

(57) ABSTRACT

An identity management system may be associated with a software plug-in for input detection of a website. In some examples, the plug-in may obtain, via an image capturing system, an image of the website that includes a set of inputs, where the set of inputs includes an interactive interface element. Using the obtained image, a set of location predictions for the set of inputs of the website may be generated via a machine learning (ML) model. Further, the plug-in may obtain a set of locations of the set of inputs based on generating the set of location predictions. Thus, the plug-in may automatically, and in response to obtaining the set of locations of the set of inputs of the website, input content into the set of inputs of the website, select an interactive interface element on the website, or both, on the behalf of the user.

### FIELD OF TECHNOLOGY

The present disclosure relates generally to identity management, and more specifically to automatic website input detection.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

In some examples, when accessing an application, a user may be prompted to input information within one or more input fields. For example, a user may be prompted to input login information (e.g., a username and password) when logging into the application. In some cases, such input information for a user may be stored in a software platform that is associated with the identity management system and the software platform can automatically fill out the input fields with the respective information for the user. For example, a user may use a browser software extension or plug-in to automatically insert login information stored in the software platform. To determine the location of the input fields for the input information, the software extension or plug-in may search the metadata of a webpage. However, searching the metadata of an unknown webpage may be relatively inefficient and can be relatively unreliable if metadata format is unknown. Further, users may still have to select interactive elements on the webpage that are associated with the input fields.

### SUMMARY

A method for input detection of a website by an apparatus is described. The method may include obtaining, via an image capturing system, an image of the website that includes a set of inputs, generating, via a machine learning model, a set of location predictions for the set of inputs of the website based on obtaining the image of the website, obtaining, based on generating the set of location predictions, a location of the set of inputs on the website based on generating the set of location predictions, and inputting, automatically and in response to obtaining the location of the set of inputs of the website, content into the set of inputs of the website.

An apparatus for input detection of a website is described. The apparatus may include one or more memories storing processor executable code, and one or more processors coupled with the one or more memories. The one or more processors may individually or collectively be operable to execute the code to cause the apparatus to obtain, via an image capturing system, an image of the website that includes a set of inputs, generate, via a machine learning model, a set of location predictions for the set of inputs of the website based on obtaining the image of the website, obtain, based on generating the set of location predictions, a location of the set of inputs on the website based on generating the set of location predictions, and input, automatically and in response to obtaining the location of the set of inputs of the website, content into the set of inputs of the website.

Another apparatus for input detection of a website is described. The apparatus may include means for obtaining, via an image capturing system, an image of the website that includes a set of inputs, means for generating, via a machine learning model, a set of location predictions for the set of inputs of the website based on obtaining the image of the website, means for obtaining, based on generating the set of location predictions, a location of the set of inputs on the website based on generating the set of location predictions, and means for inputting, automatically and in response to obtaining the location of the set of inputs of the website, content into the set of inputs of the website.

A non-transitory computer-readable medium storing code for input detection of a website is described. The code may include instructions executable by one or more processors to obtain, via an image capturing system, an image of the website that includes a set of inputs, generate, via a machine learning model, a set of location predictions for the set of inputs of the website based on obtaining the image of the website, obtain, based on generating the set of location predictions, a location of the set of inputs on the website based on generating the set of location predictions, and input, automatically and in response to obtaining the location of the set of inputs of the website, content into the set of inputs of the website.

Some examples of the method, apparatus, and non-transitory computer-readable medium described herein may further include operations, features, means, or instructions for transmitting, to the machine learning model, the image of the website, where the set of location predictions may be generated based on transmitting the image of the website to the machine learning model.

Some examples of the method, apparatus, and non-transitory computer-readable medium described herein may further include operations, features, means, or instructions for generating, via the machine learning model, a location prediction for an interactive interface element of the website, obtaining, based on generating the location prediction for the interactive interface element, a location of the interactive interface element on the website, and selecting, in response to obtaining the location of the interactive interface element of the website and inputting the content into the set of inputs of the website, the interactive interface element of the website.

In some examples of the method, apparatus, and non-transitory computer-readable medium described herein, the set of inputs of the website include one or more input fields and one or more interactive interface elements.

Some examples of the method, apparatus, and non-transitory computer-readable medium described herein may further include operations, features, means, or instructions for transmitting, to an authentication server, a query for content associated with a user and receiving, from the authentication server and in response to the query, the content associated with the user, where inputting the content automatically into the set of inputs of the website may be based on receiving the content from the authentication server.

In some examples of the method, apparatus, and non-transitory computer-readable medium described herein, the set of inputs include a username input field, a password input field, a submit button, or any combination thereof.

In some examples of the method, apparatus, and non-transitory computer-readable medium described herein, generating the set of location predictions may include operations, features, means, or instructions for generating, via the machine learning model, one or more coordinate predictions associated with a respective input of a set of inputs of a website, where the set of location predictions include one or more coordinate predictions.

In some examples of the method, apparatus, and non-transitory computer-readable medium described herein, obtaining the location of the set of inputs of the website may include operations, features, means, or instructions for transforming the one or more coordinate predictions to match a size of the website on a computing device, a resolution of the website on the computing device, or both.

In some examples of the method, apparatus, and non-transitory computer-readable medium described herein, obtaining the location of the set of inputs of the website may include operations, features, means, or instructions for searching metadata associated with the website for the location of the set of inputs based on generating the set of location predictions.

In some examples of the method, apparatus, and non-transitory computer-readable medium described herein, the machine learning model may be trained via a set of training parameters associated with a set of images of a set of websites that include indications of a set of actual locations of a set of inputs within a respective image.

### BRIEF DESCRIPTION OF THE DRAWINGS

FIG. 1 illustrates an example of a computing system that supports automatic website input detection in accordance with aspects of the present disclosure.

FIG. 2 shows an example of a software extension diagram that supports automatic website input detection in accordance with aspects of the present disclosure.

FIG. 3 shows an example of a website login page that supports automatic website input detection in accordance with aspects of the present disclosure.

FIG. 4 shows an example of a process flow that supports automatic website input detection in accordance with aspects of the present disclosure.

FIG. 5 shows a block diagram of an apparatus that supports automatic website input detection in accordance with aspects of the present disclosure.

FIG. 6 shows a block diagram of a software extension module that supports automatic website input detection in accordance with aspects of the present disclosure.

FIG. 7 shows a diagram of a system including a device that supports automatic website input detection in accordance with aspects of the present disclosure.

FIGS. 8 and 9 show flow charts illustrating methods that support automatic website input detection in accordance with aspects of the present disclosure.

### DETAILED DESCRIPTION

In some examples, when logging into a website a user may use a browser extension or a plug-in to automatically input login information for the user. For example, the plug-in may be associated with a data store of user information or may directly store the user information and input the user information within input fields of a webpage based on detecting the input fields. To detect the input fields the plug-in may search through the metadata of a respective website to find the metadata associated with the input fields and then enter the corresponding information. However, searching for the input fields on a website by searching the metadata of a website may be relatively time-consuming and inefficient. For example, if the website is in an unknown language or if the format of the metadata is unknown to the plug-in, the plug-in may be unable to reliably enter information into input fields for the user.

To reliably enter information into input fields of a website a plug-in may use image detection via a machine learning (ML) model to detect the location of input fields and buttons on a website to automatically fill in content for a user. For example, the plug-in may obtain, via an image capturing system, an image of a website that includes a set of inputs (e.g., input fields). The plug-in may then use a ML model to generate a set of location predictions for the set of inputs of the website based on obtaining the image of the website. Further, the plug-in may obtain a set of locations of the set of inputs based on generating the set of location predictions and input, automatically and in response to obtaining the set of locations, content into the website. Thus, the techniques of the present disclosure may enable plug-ins and other software to automatically input content into input fields of a website relatively more reliably and efficiently.

In some cases, to generate the set of location predictions, the image of the website may be transmitted to the ML model. Moreover, the ML model may be trained on a set of images of different websites with input fields prelabeled. Further, in some examples, the location of the set of inputs may be obtained based on searching the metadata of a website using the set of location predictions generated by the ML model. For example, the plug-in may perform a narrowed search of the metadata using the set of location predictions and find the set of locations of the set of inputs based on performing the narrowed search. Moreover, such search may be relatively efficient compared to searching the metadata of the entire website. Additionally, or alternatively, the techniques of the present disclosure may be used to find and select interactive elements of a website (e.g., buttons). For example, the plug-in may use the ML model to predict a location of a button on a website, such as an enter or log-in button, search the metadata within the predicted location of the button to obtain the location of the button, and select the button in response to obtaining the location of the button.

Therefore, the techniques of the present disclosure may provide relatively more efficient and reliable techniques of automatically inputting content into input fields of a website, selecting interactive elements based on inputting the content, or both. For example, the techniques of the present disclosure may enable a plug-in that can automatically login a user to an application to be used regardless of the language or format of the application. Additionally, or alternatively, the techniques of the present disclosure may enable plugins to automatically enter any type of information into input fields for a user based on accessing and communicating with an authentication server that stores information associated with the user.

Aspects of the disclosure are initially described in the context of a computing system. Additional aspects of the disclosure are described with reference to a software extension diagram, a website login page example, and a process flow. Aspects of the disclosure are further illustrated by and described with reference to apparatus diagrams, system diagrams, and flow charts that relate to automatic website input detection.

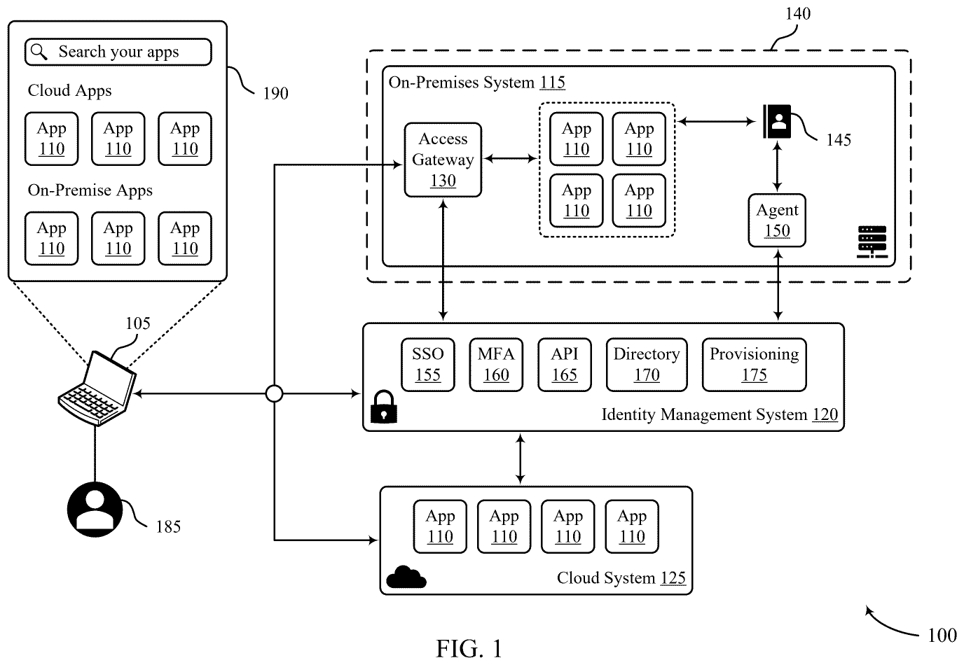

FIG. 1 illustrates an example of a computing system 100 that supports automatic website input detection in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

In some examples, within an application 110, a user 185 may be prompted to input information on a user interface of the application 110 on a computing device 105. For example, the user 185 may attempt to sign-in to an application 110 via a log-in page of a website. In some cases, the page of the website may include a set of input fields (e.g., text input fields, buttons, and the like) for the user 185 to input content into, select, or both. In some examples, the user 185 may store the content to be input into the website in a software platform such as a password management service. The software platform may further be connected to a plug-in or software extension that a website may use to input the information.

In accordance with the techniques of the present disclosure, to reliably enter information into input fields of a website a plug-in may use image detection via a ML model to detect the location of input fields and buttons on a website to automatically fill in content for a user 185. For example, the plug-in may obtain, via an image capturing system, an image of a website that includes a set of inputs (e.g., input fields). The plug-in may then use a ML model to generate a set of location predictions for the set of inputs of the website based on obtaining the image of the website. Further, the plug-in may obtain a set of locations of the set of inputs based on generating the set of location predictions and input, automatically and in response to obtaining the set of locations, content into the website. Thus, the techniques of the present disclosure may enable plug-ins and other software to automatically input content into input fields of a website relatively more reliably and efficiently.

Moreover, the techniques of the present disclosure may provide relatively more efficient and reliable techniques of automatically inputting content into input fields of a website, selecting interactive elements based on inputting the content, or both. For example, the techniques of the present disclosure may enable a plug-in that can automatically login a user to an application to be used regardless of the language or format of the application. Additionally, or alternatively, the techniques of the present disclosure may enable plugins to automatically enter any type of information into input fields for a user 185 based on accessing and communicating with an authentication server that stores information associated with the user. For example, a plugin may be capable of automatically inputting information in fields such as credit card fields, address fields, and the like.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

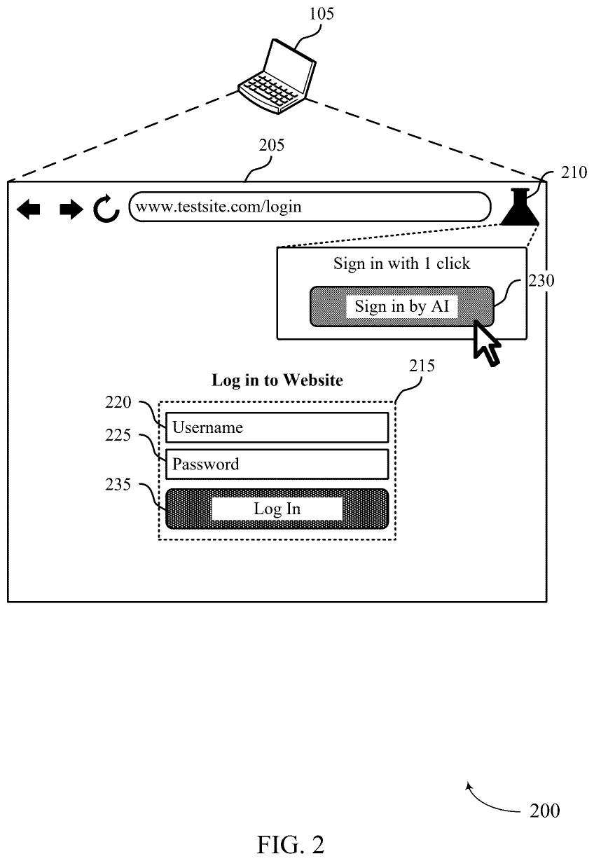

FIG. 2 shows an example of a website login page 200 that supports automatic website input detection in accordance with aspects of the present disclosure. In some examples, the website login page 200 may implement or be implemented by the system 100. For example, a computing device 105 may display the website login page 200 via a user interface to a user 185, which may represent examples of corresponding devices or services described herein with reference to FIG. 1. Moreover, in some cases, the website login page 200 may include a website 205, a plug-in 210, and a set of inputs 215 within the website 205.

In some examples, software platforms may store information for users 185 that can be input within the set of inputs 215 of the website. For example, a software platform may be a website authentication platform, a password manager, or the like. In some cases, the software platform may be connected to a plug-in 210 that is capable of the set of inputs 215. For example, the set of inputs 215 may include a username input 220 and a password input 225 that may be text input boxes within the website 205. In some cases, the plug-in 210 may be capable of identifying the username input 220 and the password input 225 within the website 205 through searching the metadata of the website 205 that is associated with the set of inputs 215 of the website 205. In some cases, the metadata of a website 205 may refer to the underlying information of the website 205 that includes descriptions, locations, and the like of elements of the website to enable improved searching and understanding of the content and context of the website 205. Once the plug-in 210 obtains the locations of the set of inputs 215 the plug-in 210 may input information into the set of inputs 215. For example, the plug-in 210 may enter a username for a user 185 associated with the website 205 into the username input 220 and a password that is associated with both the user 185 and the entered username into the password input 225. By entering such content based on identifying the set of inputs 215 from searching the metadata of the website 205 the plug-in 210 may be capable of reducing the latency associated with entering content into the set of inputs 215.

However, in some cases, searching for the set of inputs 215 within the metadata of the website 205 may be relatively inefficient. For example, a website 205 may follow different naming conventions of fields leading to inconsistencies in the capabilities of the plug-in 210 to identify various fields such as input fields (e.g., the set of inputs 215). Further, a website 205 may implement relatively complex structures, dynamic elements, and the like that can make it relatively difficult for the plug-in 210 to identify the correct fields for the set of inputs 215. Moreover, having the metadata of a website 205 be in a standardized format that can be easily searched by a plug-in 210 may be relatively insecure and can result in one or more cybersecurity attacks. For example, a malicious actor may perform a phishing attack to obtain information by generating a website 205 that is malicious and mimics or mirrors the metadata of a website 205 that is legitimate to trick plug-in 210 into entering the username and password for a user into inputs within the malicious website. Thus, the malicious actor may be capable of obtaining sensitive information that can be used to gain access to applications 110 and services containing further sensitive information. Therefore, such techniques of having a website 205 use a standardized metadata format and using a plug-in 210 to search the metadata of a website 205 for a set of inputs 215 while relatively simplistic may be inaccurate, inefficient, and insecure.

To improve the accuracy, efficiency, and security of using a plug-in 210 to identify a set of inputs 215 within a website, the techniques of the present disclosure may describe using computer vision based techniques. For example, the techniques of the present disclosure may describe a user 185 selecting a sign-in button 230 to activate the plug-in 210 that performs an artificial intelligence (AI) based input detection procedure. Moreover, the plug-in 210 may use one or more image-based input detection algorithms to identify and locate inputs and interactive elements within a website 205 more accurately. For example, the techniques of the present disclosure may describe the plug-in 210 being capable of identifying the username input 220, the password input 225, and a login button 235 associated with the login procedure. Moreover, after identifying the login button 235, the plug-in 210 may also be capable of selecting the login button 235 in addition to inputting content (e.g., a username and password) into the username input 220 and the password input 225. In some cases, the login button 235 and any other type of button or element that expects a selection may also be referred to as an interactive element of a website 205 elsewhere herein. Further, an interactive element may be an example of an element of a website 205 that expects a form of selection. For example, a button, a checkbox, and the like that expect to be selected by a user 185 may be examples of interactive elements.

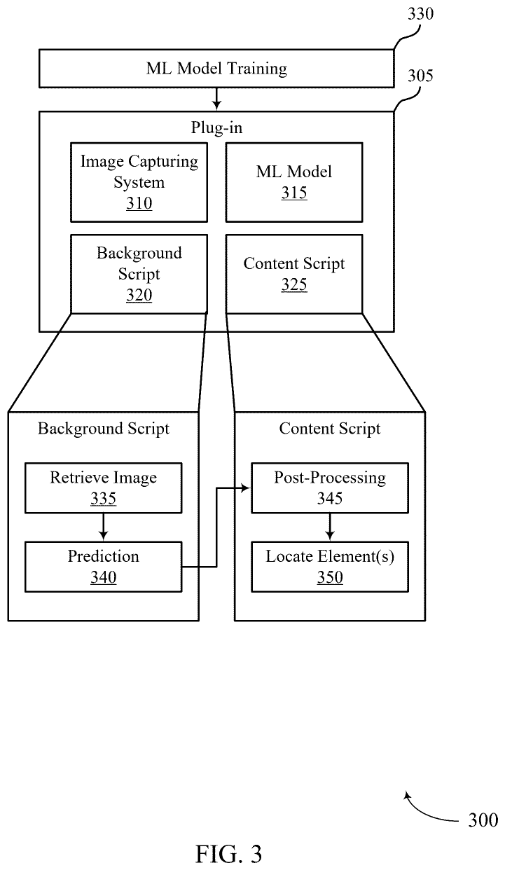

Thus, the techniques of the present disclosure may enable the plug-in 210 to select an interactive element in conjunction with or after inputting content into input fields such as the username input 220 and the password input 225. Therefore, the techniques of the present disclosure may enhance the performance of the plug-in 210 to automate processes associated with inputting content into fields of a website. For example, the plug-in 210 may be capable of automating login procedures and content input procedures for users 185 to reduce latency associated with such procedures. Moreover, the techniques of the present disclosure may ensure that the operations of the plug-in 210 are secure to improve the security of applications and services and prevent sensitive information from being obtained by malicious actors. Further descriptions of the identification procedure performed by the plug-in 210 in accordance with the techniques of the present disclosure may be described elsewhere herein such as with reference to FIG. 3.

FIG. 3 shows an example of a software extension diagram 300 that supports automatic website input detection in accordance with aspects of the present disclosure. In some examples, the software extension diagram 300 may implement or be implemented by the system 100. Further, the software extension diagram 300 may illustrate the procedure of using the plug-in 210 on the website 205 illustrated in the website login page 200 in accordance with the techniques of the present disclosure. For example, the software extension diagram 300 may include a plug-in 305 that may represent examples of corresponding devices or services described herein with reference to FIGS. 1 and 2 (e.g., the plug-in 210 illustrated and described with reference to FIG. 2). Moreover, in some cases, the term “software extension” may refer to a computer program that is executed as an extension to a service. For example, the plug-in 305 may be an example of a software extension that is executed within an internet browser and on a website. Additionally, or alternatively, a software extension or a plug-in 305 that operates for an internet browser may also be referred to as a browser extension.

In some examples, the plug-in 305 may be associated with an image capturing system 310, an ML model 315, a background script 320, a content script 325, or any combination thereof. For example, the plug-in 305 may be capable of obtaining images of website pages (e.g., login pages or pages with a set of inputs) that can be transmitted to the ML model 315. In some cases, the ML model 315 that is associated with the plug-in 305 may be trained via a ML model training procedure 330. For example, when training the ML model 315 via the ML model training procedure 330, the ML model 315 may receive a set of training parameters that are associated with a set of training data that includes a set of prelabeled images. In some cases, the prelabeled images may include images of websites with inputs that are pre-classified as being input fields, interactive elements, and the like. For example, the ML model training procedure 330 may include a user 185 labeling images from a set of websites to indicate the location of input fields such as username fields, password fields, login buttons, or any combination thereof. Further, in some cases, the set of images in the training data may also include other types of input field classifications. For example, some images may have input fields identified that are associated with information such as credit card numbers, bank account information, address information, driver license numbers, passport information, and the like.

Therefore, when the plug-in 305 is used on a website, plug-in 305 may execute the background script 320 that utilizes the image capturing system 310 and the ML model 315. For example, based on an input from a user 185, the plug-in 305 may execute the background script 320. In some cases, the background script 320 may utilize the image capturing system 310 to perform an image retrieval procedure 335 and then send the obtained image of a website to the ML model 315 to perform a prediction procedure 340. In some examples, via the prediction procedure 340, the ML model 315 may use the obtained image of the website to generate a set of location predictions for a set of inputs of the website. For example, the ML model 315 may generate a set of coordinates of the website that the set of inputs may be within. Moreover, the set of location predictions may include a prediction that the set of inputs may be within a portion of the website that is indicated via the set of coordinates. For example, the ML model 315 may output a set of coordinates of the website (e.g., a top-left and a bottom-right corner, or vice versa) of a portion of the website that a set of inputs (e.g., a username input field, a password input field, an interactive element, or any combination thereof). Additionally, or alternatively, the ML model 315 may output, via the prediction procedure 340, a set of location predictions for each input field individually. For example, the ML model 315 may output a first set of location predictions for a username field, a second set of location predictions for a password field, and a third set of location predictions for an interactive element.

Based on executing the background script 320 and generating the set of location predictions via the ML model 315, the plug-in 305 may execute the content script 325. When executing the content script 325, the plug-in 305 may perform a post-processing procedure 345 to obtain a location of the set of inputs on the website. In some cases, the post-processing procedure 345 may include the plug-in 305 determining a subset of metadata of the website that corresponds to the set of location predictions of the set of inputs. For example, the plug-in 305 may use the post-processing procedure 345 to determine what portions of the metadata of the website correspond to the coordinates indicated by the set of location predictions generated via the ML model 315. In some cases, the post-processing procedure 345 may also include the plug-in 305 transforming the one or more coordinate positions predicted by the ML model 315 to match a size of the website on a computing device 105, a resolution of the website on the computing device 105, or both.

Following obtaining the location of the set of inputs, the plug-in 305 may perform a location procedure 350 to locate the fields and elements associated with the set of inputs. For example, the plug-in 305 may perform a narrowed search of the metadata of the website to obtain a document object model (DOM) element for each input in the set of inputs. Thus, in response to obtaining the location of the set of inputs and the DOM of the inputs of the website, the plug-in 305 may automatically input content into the set of inputs of the website. For example, if the webpage is a login page of a website, the plug-in 305 may obtain an image of the login page via the image capturing system 310 in the image retrieval procedure 335 and then generate the set of location predictions of the login input fields using the ML model 315 via the prediction procedure 340. Based on generating the set of location predictions, the plug-in 305 may obtain the location of the login input fields of the website via the post-processing procedure 345 and the location procedure 350. Therefore, in response to obtaining the location, the plug-in 305 may automatically input login information (e.g., content) within the login input fields and select a login button (e.g., an interactive interface element) on behalf of the user 185 to log the user 185 into the website.

In some cases, to obtain the content to automatically input into the set of inputs, the plug-in 305 may query an authentication server. For example, in response to a request from a user 185 for the plug-in 305 to log-in to a website, application, or service, the plug-in 305 may transmit a query to an authentication server for the log-in information associated with user 185. The plug-in 305 may then receive a response to the query from the authentication server that includes the content associated with the user 185 for the plug-in 305 to automatically input into the set of inputs of a website. In some examples, the set of inputs may correspond to other forms of information input fields. For example, a website may have an input field associated with credit card information or banking information for a user 185 to make a payment and the plug-in 305 may be capable of automatically inputting the corresponding content in response to identifying the location of the inputs and selecting an interactive interface element that is associated with the inputs (e.g., a complete purchase button). In such examples, the plug-in 305 may be connected to, may communicate with, or both with a service that stores such personal information for a user 185. For example, the plug-in 305 may communicate with an authentication server, a data store, a software platform such as a password manager, or any combination thereof to obtain the content to input into the set of inputs of a website.

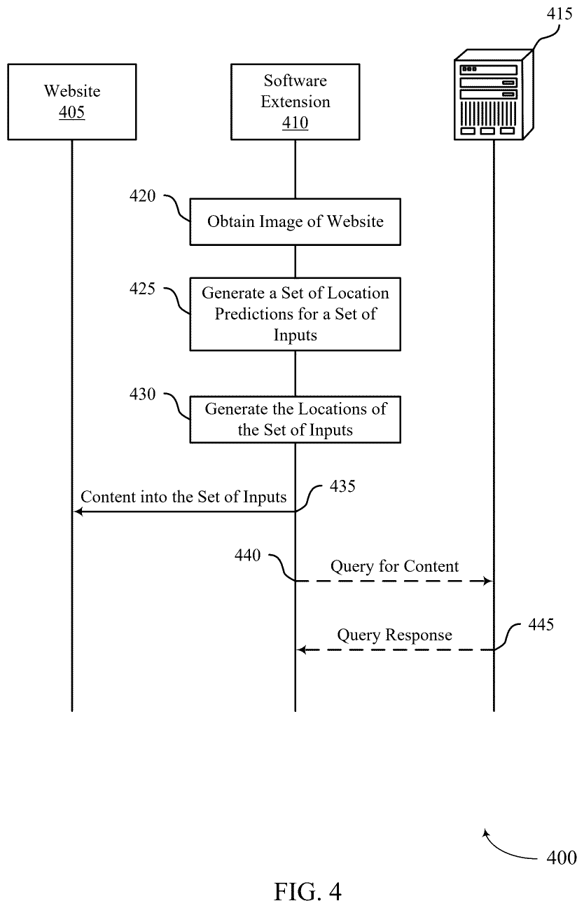

Thus, the techniques of the present disclosure may enable a plug-in 305 to identify and input content using the image capturing system 310 and the ML model 315 to more accurately, securely, reliably, and efficiently automatically input content into a website for a user. Moreover, the techniques of the present disclosure may enable the plug-in 305 to be capable of searching a relatively small portion of metadata to increase the reliability and accuracy of obtaining the location of the set of inputs of a respective website. Additionally, or alternatively, the techniques of the present disclosure may reduce the time consumption and reduce the consumption of computational resources by searching a relatively smaller portion of metadata of a website. Therefore, in accordance with the techniques of the present disclosure, the operations of the plug-in 305 may detect locations of inputs on a website and automatically input content or selecting inputs based on detecting the locations of the inputs more accurately, reliably, and efficiently. Further descriptions of the techniques of the present disclosure may be described elsewhere herein, such as with reference to FIG. 4.

FIG. 4 shows an example of a process flow 400 that supports automatic website input detection in accordance with aspects of the present disclosure. In some examples, the process flow 400 may implement or be implemented by the system 100, the website login page 200, the software extension diagram 300, or any combination thereof. For example, the process flow 400 may include a website 405, a software extension 410, and an authentication server 415, which may be examples of devices described herein with reference to FIGS. 1 through 3. Further, it should be understood by someone having ordinary skill in the art that the software extension 410 may be an example of a plug-in, a browser extension, or any other type of service that is executed or operates within an internet browser, application, service, or any combination thereof.

In the following description of the process flow 400, the operations between the website 405, the software extension 410, and the authentication server 415 may be performed in different orders or at different times. Some operations may also be left out of the process flow 400, or other operations may be added. Although the website 405, the software extension 410, and the authentication server 415 are shown performing the operations of the process flow 400, some aspects of some operations may also be performed by one or more other wireless devices.

At 420, an image capturing system of the software extension 410 may obtain an image of website 405 that includes a set of inputs. In some examples, the image capturing system may transmit the image of the website 405 to a machine learning model of the software extension 410, where the set of location predictions is generated based on transmitting the image of the website 405 to the machine learning model. In some cases, the set of inputs of the website 405 may include one or more input fields and one or more interactive interface elements. Additionally, or alternatively, the set of inputs may include a username input field, a password input field, a submit button, or any combination thereof.

At 425, a machine learning model of the software extension 410 may generate a set of location predictions for the set of inputs of the website 405 based on obtaining the image of the website 405. In some examples, the machine learning model may generate a location prediction for an interactive interface element of website 405. Moreover, the machine learning model may generate one or more coordinate predictions associated with a respective input of a set of inputs of the website 405, where the set of location predictions include one or more coordinate predictions. Further, in some cases, the machine learning model may be trained via a set of training parameters associated with a set of images of a set of websites that include indications of a set of actual locations of a set of inputs within a respective image.

At 430, the software extension 410 may obtain a location of the set of inputs on the website 405 based on generating the set of location predictions. In some examples, obtaining the location of the set of inputs of the website 405 may include transforming the one or more coordinate predictions to match a size of the website 405 on a computing device, a resolution of the website 405 on the computing device, or both. Further, obtaining the location of the set of inputs of the website 405 may include searching metadata associated with website 405 for the location of the set of inputs based on generating the set of location predictions. Additionally, or alternatively, the software extension 410 may obtain a location of the interactive interface element on the website 405 based on generating the location prediction for the interactive interface element.

At 435, the software extension 410 may automatically input content into the set of inputs of the website 405 in response to obtaining the location of the set of inputs of the website 405. In some examples, the software extension 410 may select the interactive interface element of the website 405 in response to obtaining the location of the interactive interface element of website 405 and inputting the content into the set of inputs of the website 405.

At 440, the software extension 410 may transmit, to the authentication server 415, a query for content associated with a user. At 445, the software extension 410 may receive, from the authentication server 415, the content associated with the user in response to the query. In some examples, the software extension 410 may automatically input the content into the set of inputs of the website 405 may be based on receiving the content from authentication server 415.

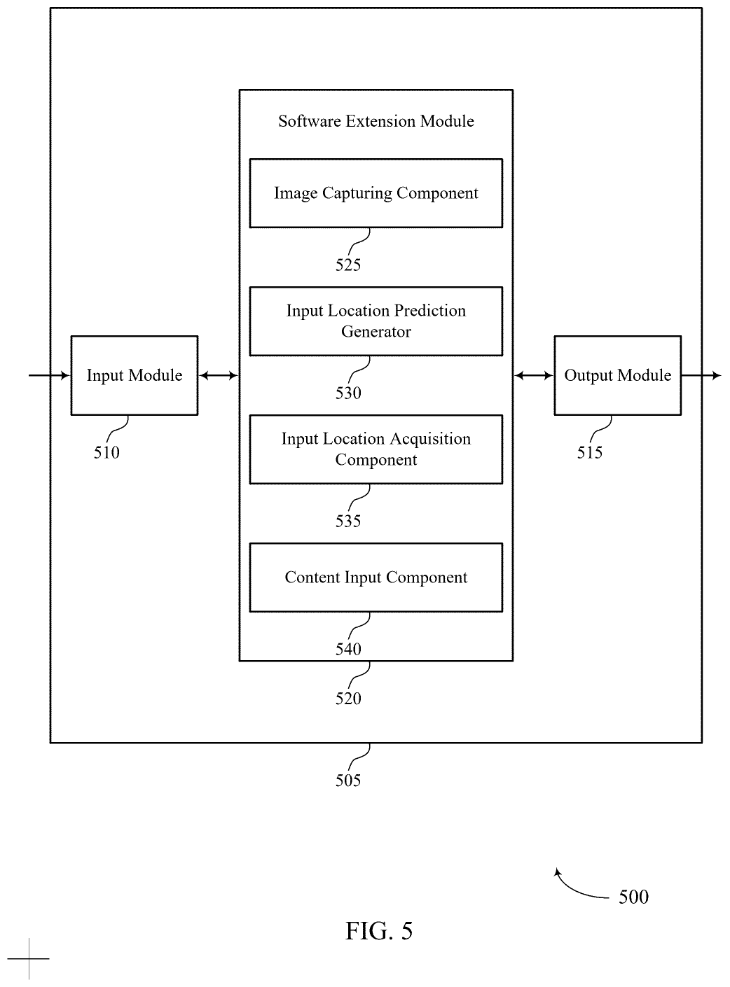

FIG. 5 shows a block diagram 500 of a device 505 that supports automatic website input detection in accordance with aspects of the present disclosure. The device 505 may include an input module 510, an output module 515, and a software extension module 520. The device 505, or one or more components of the device 505 (e.g., the input module 510, the output module 515, the software extension module 520), may include at least one processor, which may be coupled with at least one memory, to support the described techniques. Each of these components may be in communication with one another (e.g., via one or more buses).

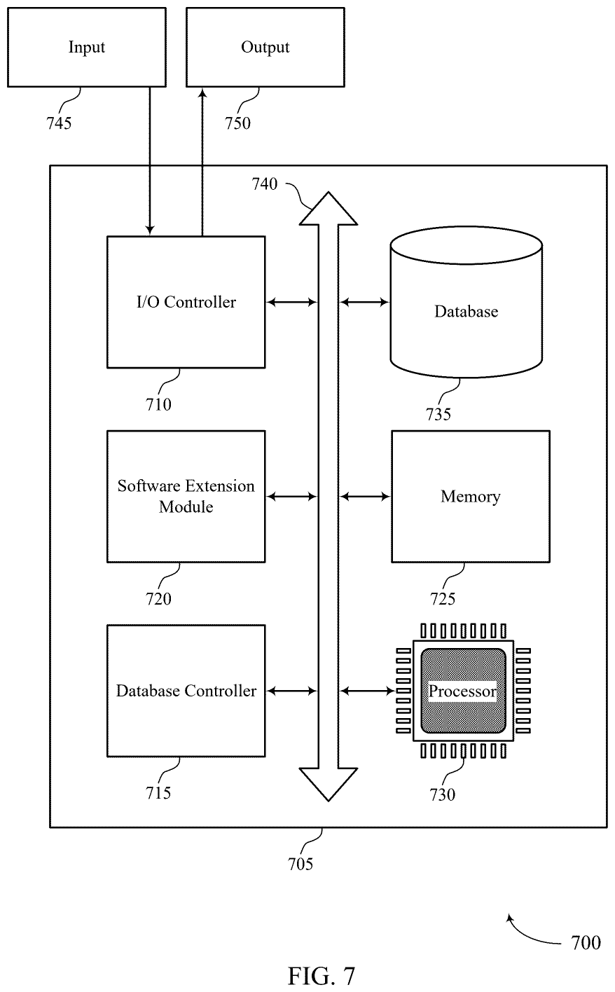

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the software extension module 520 to support automatic website input detection. In some cases, the input module 510 may be a component of an input/output (I/O) controller 710 as described with reference to FIG. 7.

The output module 515 may manage output signals for the device 505. For example, the output module 515 may receive signals from other components of the device 505, such as the software extension module 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the software extension module 520 may include an image capturing component 525, an input location prediction generator 530, an input location acquisition component 535, a content input component 540, or any combination thereof. In some examples, the software extension module 520, or various components thereof, may be configured to perform various operations (e.g., receiving, monitoring, transmitting) using or otherwise in cooperation with the input module 510, the output module 515, or both. For example, the software extension module 520 may receive information from the input module 510, send information to the output module 515, or be integrated in combination with the input module 510, the output module 515, or both to receive information, transmit information, or perform various other operations as described herein.

The software extension module 520 may support input detection of a website in accordance with examples as disclosed herein. The image capturing component 525 may be configured to support obtaining, via an image capturing system, an image of the website that includes a set of inputs. The input location prediction generator 530 may be configured to support generating, via a machine learning model, a set of location predictions for the set of inputs of the website based on obtaining the image of the website. The input location acquisition component 535 may be configured to support obtaining, based on generating the set of location predictions, a location of the set of inputs on the website based on generating the set of location predictions. The content input component 540 may be configured to support inputting, automatically and in response to obtaining the location of the set of inputs of the website, content into the set of inputs of the website.

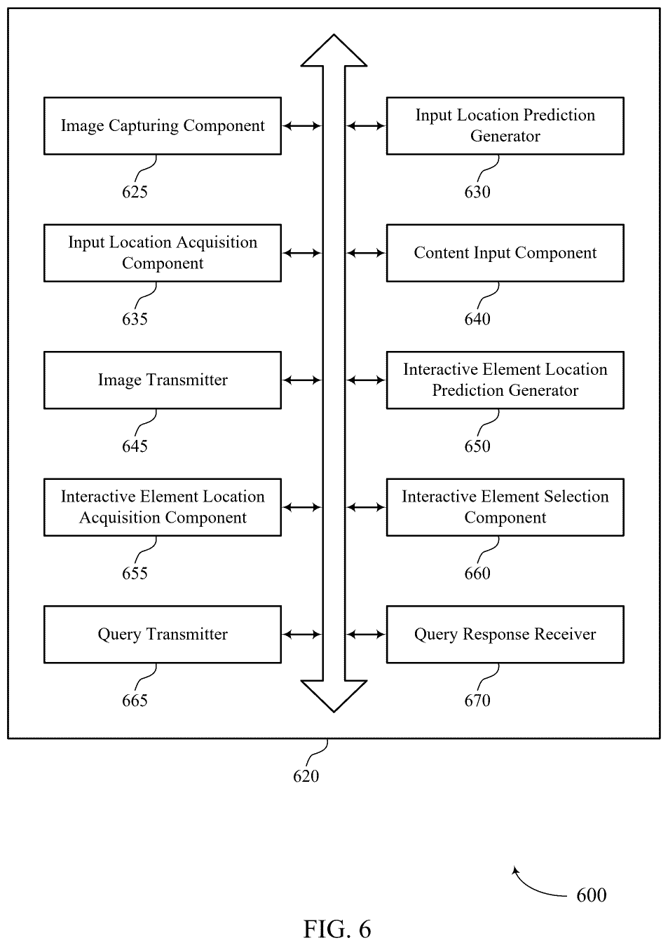

FIG. 6 shows a block diagram 600 of a software extension module 620 that supports automatic website input detection in accordance with aspects of the present disclosure. The software extension module 620 may be an example of aspects of a software extension module or a software extension module 520, or both, as described herein. The software extension module 620, or various components thereof, may be an example of means for performing various aspects of automatic website input detection as described herein. For example, the software extension module 620 may include an image capturing component 625, an input location prediction generator 630, an input location acquisition component 635, a content input component 640, an image transmitter 645, an interactive element location prediction generator 650, an interactive element location acquisition component 655, an interactive element selection component 660, a query transmitter 665, a query response receiver 670, or any combination thereof. Each of these components, or components of subcomponents thereof (e.g., one or more processors, one or more memories), may communicate, directly or indirectly, with one another (e.g., via one or more buses).

The software extension module 620 may support input detection of a website in accordance with examples as disclosed herein. The image capturing component 625 may be configured to support obtaining, via an image capturing system, an image of the website that includes a set of inputs. The input location prediction generator 630 may be configured to support generating, via a machine learning model, a set of location predictions for the set of inputs of the website based on obtaining the image of the website. The input location acquisition component 635 may be configured to support obtaining, based on generating the set of location predictions, a location of the set of inputs on the website based on generating the set of location predictions. The content input component 640 may be configured to support inputting, automatically and in response to obtaining the location of the set of inputs of the website, content into the set of inputs of the website.

In some examples, the image transmitter 645 may be configured to support transmitting, to the machine learning model, the image of the website, where the set of location predictions is generated based on transmitting the image of the website to the machine learning model.

In some examples, the interactive element location prediction generator 650 may be configured to support generating, via the machine learning model, a location prediction for an interactive interface element of the website. In some examples, the interactive element location acquisition component 655 may be configured to support obtaining, based on generating the location prediction for the interactive interface element, a location of the interactive interface element on the website. In some examples, the interactive element selection component 660 may be configured to support selecting, in response to obtaining the location of the interactive interface element of the website and inputting the content into the set of inputs of the website, the interactive interface element of the website.

In some examples, the set of inputs of the website include one or more input fields and one or more interactive interface elements.

In some examples, the query transmitter 665 may be configured to support transmitting, to an authentication server, a query for content associated with a user. In some examples, the query response receiver 670 may be configured to support receiving, from the authentication server and in response to the query, the content associated with the user, where inputting the content automatically into the set of inputs of the website is based on receiving the content from the authentication server.

In some examples, the set of inputs include a username input field, a password input field, a submit button, or any combination thereof.

In some examples, to support generating the set of location predictions, the input location prediction generator 630 may be configured to support generating, via the machine learning model, one or more coordinate predictions associated with a respective input of a set of inputs of a website, where the set of location predictions include one or more coordinate predictions.

In some examples, to support obtaining the location of the set of inputs of the website, the input location acquisition component 635 may be configured to support transforming the one or more coordinate predictions to match a size of the website on a computing device, a resolution of the website on the computing device, or both.

In some examples, to support obtaining the location of the set of inputs of the website, the input location acquisition component 635 may be configured to support searching metadata associated with the website for the location of the set of inputs based on generating the set of location predictions.

In some examples, the machine learning model is trained via a set of training parameters associated with a set of images of a set of websites that include indications of a set of actual locations of a set of inputs within a respective image.

FIG. 7 shows a diagram of a system 700 including a device 705 that supports automatic website input detection in accordance with aspects of the present disclosure. The device 705 may be an example of or include components of a device 505 as described herein. The device 705 may include components for bi-directional voice and data communications including components for transmitting and receiving communications, such as a software extension module 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting automatic website input detection). The processor 730 may be an example of a single processor or multiple processors. For example, the device 705 may include one or more processors 730.

The software extension module 720 may support input detection of a website in accordance with examples as disclosed herein. For example, the software extension module 720 may be configured to support obtaining, via an image capturing system, an image of the website that includes a set of inputs. The software extension module 720 may be configured to support generating, via a machine learning model, a set of location predictions for the set of inputs of the website based on obtaining the image of the website. The software extension module 720 may be configured to support obtaining, based on generating the set of location predictions, a location of the set of inputs on the website based on generating the set of location predictions. The software extension module 720 may be configured to support inputting, automatically and in response to obtaining the location of the set of inputs of the website, content into the set of inputs of the website.

By including or configuring the software extension module 720 in accordance with examples as described herein, the device 705 may support techniques for automatically inputting content into input fields of a website to support reduced latency, improved user experience, and increased security.

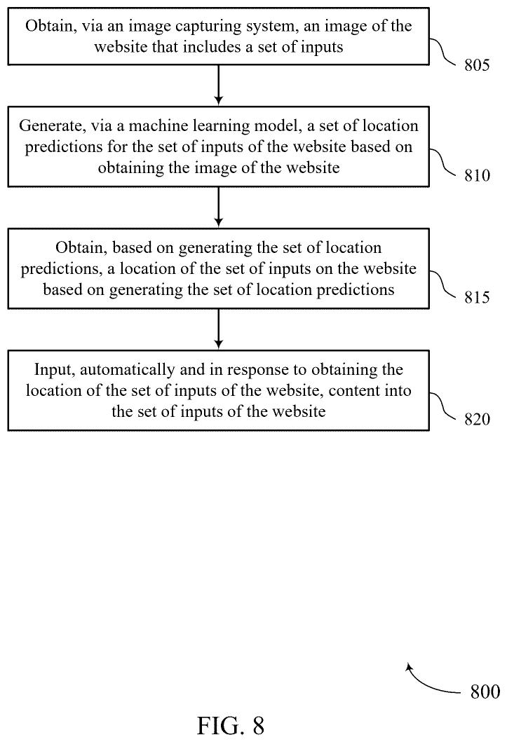

FIG. 8 shows a flow chart illustrating a method 800 that supports automatic website input detection in accordance with aspects of the present disclosure. The operations of the method 800 may be implemented by a computing device or its components as described herein. For example, the operations of the method 800 may be performed by a computing device as described with reference to FIGS. 1 through 7. In some examples, a computing device may execute a set of instructions to control the functional elements of the computing device to perform the described functions. Additionally, or alternatively, the computing device may perform aspects of the described functions using special-purpose hardware.

At 805, the method may include obtaining, via an image capturing system, an image of the website that includes a set of inputs. The operations of 805 may be performed in accordance with examples as disclosed herein. In some examples, aspects of the operations of 805 may be performed by an image capturing component 625 as described with reference to FIG. 6.

At 810, the method may include generating, via a machine learning model, a set of location predictions for the set of inputs of the website based on obtaining the image of the website. The operations of 810 may be performed in accordance with examples as disclosed herein. In some examples, aspects of the operations of 810 may be performed by an input location prediction generator 630 as described with reference to FIG. 6.

At 815, the method may include obtaining, based on generating the set of location predictions, a location of the set of inputs on the website based on generating the set of location predictions. The operations of 815 may be performed in accordance with examples as disclosed herein. In some examples, aspects of the operations of 815 may be performed by an input location acquisition component 635 as described with reference to FIG. 6.

At 820, the method may include inputting, automatically and in response to obtaining the location of the set of inputs of the website, content into the set of inputs of the website. The operations of 820 may be performed in accordance with examples as disclosed herein. In some examples, aspects of the operations of 820 may be performed by a content input component 640 as described with reference to FIG. 6.

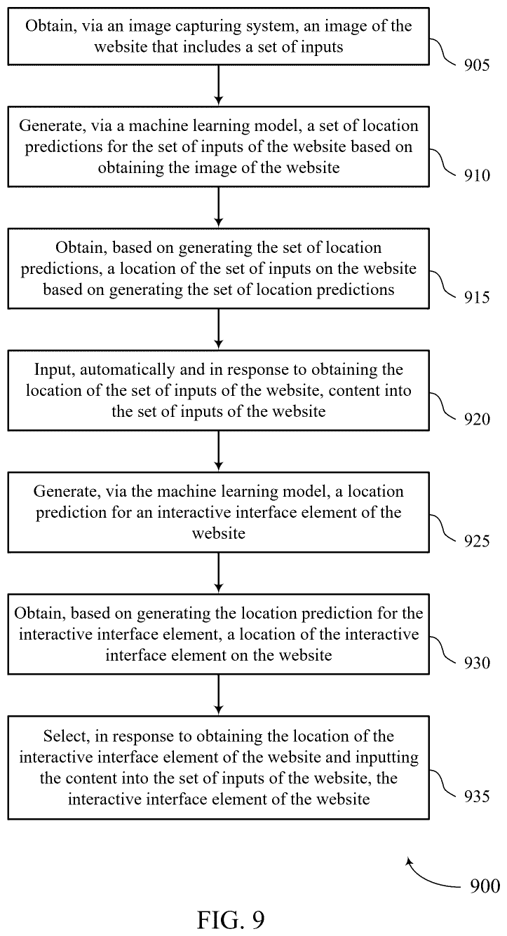

FIG. 9 shows a flow chart illustrating a method 900 that supports automatic website input detection in accordance with aspects of the present disclosure. The operations of the method 900 may be implemented by a computing device or its components as described herein. For example, the operations of the method 900 may be performed by a computing device as described with reference to FIGS. 1 through 7. In some examples, a computing device may execute a set of instructions to control the functional elements of the computing device to perform the described functions. Additionally, or alternatively, the computing device may perform aspects of the described functions using special-purpose hardware.

At 905, the method may include obtaining, via an image capturing system, an image of the website that includes a set of inputs. The operations of 905 may be performed in accordance with examples as disclosed herein. In some examples, aspects of the operations of 905 may be performed by an image capturing component 625 as described with reference to FIG. 6.

At 910, the method may include generating, via a machine learning model, a set of location predictions for the set of inputs of the website based on obtaining the image of the website. The operations of 910 may be performed in accordance with examples as disclosed herein. In some examples, aspects of the operations of 910 may be performed by an input location prediction generator 630 as described with reference to FIG. 6.

At 915, the method may include obtaining, based on generating the set of location predictions, a location of the set of inputs on the website based on generating the set of location predictions. The operations of 915 may be performed in accordance with examples as disclosed herein. In some examples, aspects of the operations of 915 may be performed by an input location acquisition component 635 as described with reference to FIG. 6.

At 920, the method may include inputting, automatically and in response to obtaining the location of the set of inputs of the website, content into the set of inputs of the website. The operations of 920 may be performed in accordance with examples as disclosed herein. In some examples, aspects of the operations of 920 may be performed by a content input component 640 as described with reference to FIG. 6.

At 925, the method may include generating, via the machine learning model, a location prediction for an interactive interface element of the website. The operations of 925 may be performed in accordance with examples as disclosed herein. In some examples, aspects of the operations of 925 may be performed by an interactive element location prediction generator 650 as described with reference to FIG. 6.

At 930, the method may include obtaining, based on generating the location prediction for the interactive interface element, a location of the interactive interface element on the website. The operations of 930 may be performed in accordance with examples as disclosed herein. In some examples, aspects of the operations of 930 may be performed by an interactive element location acquisition component 655 as described with reference to FIG. 6.

At 935, the method may include selecting, in response to obtaining the location of the interactive interface element of the website and inputting the content into the set of inputs of the website, the interactive interface element of the website. The operations of 935 may be performed in accordance with examples as disclosed herein. In some examples, aspects of the operations of 935 may be performed by an interactive element selection component 660 as described with reference to FIG. 6.

The following provides an overview of aspects of the present disclosure:
Aspect 1: A method for input detection of a website, comprising: obtaining, via an image capturing system, an image of the website that comprises a set of inputs; generating, via a machine learning model, a set of location predictions for the set of inputs of the website based at least in part on obtaining the image of the website; obtaining, based at least in part on generating the set of location predictions, a location of the set of inputs on the website based at least in part on generating the set of location predictions; and inputting, automatically and in response to obtaining the location of the set of inputs of the website, content into the set of inputs of the website.
Aspect 2: The method of aspect 1, further comprising: transmitting, to the machine learning model, the image of the website, wherein the set of location predictions is generated based at least in part on transmitting the image of the website to the machine learning model.
Aspect 3: The method of any of aspects 1 through 2, further comprising: generating, via the machine learning model, a location prediction for an interactive interface element of the website; obtaining, based at least in part on generating the location prediction for the interactive interface element, a location of the interactive interface element on the website; and selecting, in response to obtaining the location of the interactive interface element of the website and inputting the content into the set of inputs of the website, the interactive interface element of the website.
Aspect 4: The method of any of aspects 1 through 3, wherein the set of inputs of the website comprise one or more input fields and one or more interactive interface elements.
Aspect 5: The method of any of aspects 1 through 4, further comprising: transmitting, to an authentication server, a query for content associated with a user; and receiving, from the authentication server and in response to the query, the content associated with the user, wherein inputting the content automatically into the set of inputs of the website is based at least in part on receiving the content from the authentication server.
Aspect 6: The method of any of aspects 1 through 5, wherein the set of inputs comprise a username input field, a password input field, a submit button, or any combination thereof.
Aspect 7: The method of any of aspects 1 through 6, wherein generating the set of location predictions comprises: generating, via the machine learning model, one or more coordinate predictions associated with a respective input of a set of inputs of a website, wherein the set of location predictions comprise one or more coordinate predictions.
Aspect 8: The method of aspect 7, wherein obtaining the location of the set of inputs of the website comprises: transforming the one or more coordinate predictions to match a size of the website on a computing device, a resolution of the website on the computing device, or both.
Aspect 9: The method of any of aspects 1 through 8, wherein obtaining the location of the set of inputs of the website comprises: searching metadata associated with the website for the location of the set of inputs based at least in part on generating the set of location predictions.
Aspect 10: The method of any of aspects 1 through 9, wherein the machine learning model is trained via a set of training parameters associated with a set of images of a set of websites that comprise indications of a set of actual locations of a set of inputs within a respective image.
Aspect 11: An apparatus for input detection of a website, comprising one or more memories storing processor-executable code, and one or more processors coupled with the one or more memories and individually or collectively operable to execute the code to cause the apparatus to perform a method of any of aspects 1 through 10.
Aspect 12: An apparatus for input detection of a website, comprising at least one means for performing a method of any of aspects 1 through 10.
Aspect 13: A non-transitory computer-readable medium storing code for input detection of a website, the code comprising instructions executable by one or more processors to perform a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for input detection of a website, comprising:
obtaining, via an image capturing system, an image of the website that comprises a set of inputs;
generating, via a machine learning model, a set of location predictions for the set of inputs of the website based at least in part on obtaining the image of the website;
obtaining, based at least in part on generating the set of location predictions, a location of the set of inputs on the website based at least in part on generating the set of location predictions; and
inputting, automatically and in response to obtaining the location of the set of inputs of the website, content into the set of inputs of the website.

2. The method of claim 1, further comprising:
transmitting, to the machine learning model, the image of the website, wherein the set of location predictions is generated based at least in part on transmitting the image of the website to the machine learning model.

3. The method of claim 1, further comprising:
generating, via the machine learning model, a location prediction for an interactive interface element of the website;
obtaining, based at least in part on generating the location prediction for the interactive interface element, a location of the interactive interface element on the website; and
selecting, in response to obtaining the location of the interactive interface element of the website and inputting the content into the set of inputs of the website, the interactive interface element of the website.

4. The method of claim 1, wherein the set of inputs of the website comprise one or more input fields and one or more interactive interface elements.

5. The method of claim 1, further comprising:
transmitting, to an authentication server, a query for content associated with a user; and
receiving, from the authentication server and in response to the query, the content associated with the user, wherein inputting the content automatically into the set of inputs of the website is based at least in part on receiving the content from the authentication server.

6. The method of claim 1, wherein the set of inputs comprise a username input field, a password input field, a submit button, or any combination thereof.

7. The method of claim 1, wherein generating the set of location predictions comprises:
generating, via the machine learning model, one or more coordinate predictions associated with a respective input of the set of inputs of the website, wherein the set of location predictions comprise one or more coordinate predictions.

8. The method of claim 7, wherein obtaining the location of the set of inputs of the website comprises:
transforming the one or more coordinate predictions to match a size of the website on a computing device, a resolution of the website on the computing device, or both.

9. The method of claim 1, wherein obtaining the location of the set of inputs of the website comprises:
searching metadata associated with the website for the location of the set of inputs based at least in part on generating the set of location predictions.

10. The method of claim 1, wherein the machine learning model is trained via a set of training parameters associated with a set of images of a set of websites that comprise indications of a set of actual locations of a set of inputs within a respective image.

11. An apparatus for input detection of a website, comprising:
one or more memories storing processor-executable code; and
one or more processors coupled with the one or more memories and individually or collectively operable to execute the code to cause the apparatus to:
obtain, via an image capturing system, an image of the website that comprises a set of inputs;
generate, via a machine learning model, a set of location predictions for the set of inputs of the website based at least in part on obtaining the image of the website;
obtain, based at least in part on generating the set of location predictions, a location of the set of inputs on the website based at least in part on generating the set of location predictions; and
input, automatically and in response to obtaining the location of the set of inputs of the website, content into the set of inputs of the website.

12. The apparatus of claim 11, wherein the one or more processors are individually or collectively further operable to execute the code to cause the apparatus to:
transmit, to the machine learning model, the image of the website, wherein the set of location predictions is generated based at least in part on transmitting the image of the website to the machine learning model.

13. The apparatus of claim 11, wherein the one or more processors are individually or collectively further operable to execute the code to cause the apparatus to:
generate, via the machine learning model, a location prediction for an interactive interface element of the website;
obtain, based at least in part on generating the location prediction for the interactive interface element, a location of the interactive interface element on the website; and
select, in response to obtaining the location of the interactive interface element of the website and inputting the content into the set of inputs of the website, the interactive interface element of the website.

14. The apparatus of claim 11, wherein the one or more processors are individually or collectively further operable to execute the code to cause the apparatus to:
transmit, to an authentication server, a query for content associated with a user; and
receive, from the authentication server and in response to the query, the content associated with the user, wherein inputting the content automatically into the set of inputs of the website is based at least in part on receiving the content from the authentication server.

15. The apparatus of claim 11, wherein, to obtain the location of the set of inputs of the website, the one or more processors are individually or collectively operable to execute the code to cause the apparatus to:
search metadata associated with the website for the location of the set of inputs based at least in part on generating the set of location predictions.

16. A non-transitory computer-readable medium storing code for input detection of a website, the code comprising instructions executable by one or more processors to:
obtain, via an image capturing system, an image of the website that comprises a set of inputs;
generate, via a machine learning model, a set of location predictions for the set of inputs of the website based at least in part on obtaining the image of the website;
obtain, based at least in part on generating the set of location predictions, a location of the set of inputs on the website based at least in part on generating the set of location predictions; and
input, automatically and in response to obtaining the location of the set of inputs of the website, content into the set of inputs of the website.

17. The non-transitory computer-readable medium of claim 16, wherein the instructions are further executable by the one or more processors to:
transmit, to the machine learning model, the image of the website, wherein the set of location predictions is generated based at least in part on transmitting the image of the website to the machine learning model.

18. The non-transitory computer-readable medium of claim 16, wherein the instructions are further executable by the one or more processors to:
generate, via the machine learning model, a location prediction for an interactive interface element of the website;
obtain, based at least in part on generating the location prediction for the interactive interface element, a location of the interactive interface element on the website; and
select, in response to obtaining the location of the interactive interface element of the website and inputting the content into the set of inputs of the website, the interactive interface element of the website.

19. The non-transitory computer-readable medium of claim 16, wherein the instructions are further executable by the one or more processors to:
transmit, to an authentication server, a query for content associated with a user; and
receive, from the authentication server and in response to the query, the content associated with the user, wherein inputting the content automatically into the set of inputs of the website is based at least in part on receiving the content from the authentication server.

20. The non-transitory computer-readable medium of claim 16, wherein the instructions to obtain the location of the set of inputs of the website are executable by the one or more processors to:
search metadata associated with the website for the location of the set of inputs based at least in part on generating the set of location predictions.
